(19) United States
(12) Patent Application Publication
(10) Pub. No.: US 2010/0291268 A1
(43) Pub. Date: Nov. 18, 2010

(54) POPPED GRANULATED SNACKS

(75) Inventors: Warren L. Nehmer, Decatur, IL (US); Andrew Joseph Hoffman, Mount Zion, IL (US); Christopher Robert King, Decatur, IL (US)

Correspondence Address: RATNERPRESTIA, P.O. BOX 1596, WILMINGTON, DE, 19899, US

(73) Assignee: Tate & Lyle Ingredients Americas, Inc., Decatur, IL (US)

(21) Appl. No.: 12/779,364

(22) Filed: May 13, 2010

Related U.S. Application Data
(60) Provisional application No. 61/177,798, filed on May 13, 2009.

(51) Int. Cl. A23L 1/00

(52) U.S. Cl. 426/89; 426/661

(57) ABSTRACT

Poppable granules each including a heat-expandable core encapsulated by a solid coating layer including a polymer. For at least 90 wt% of the granules:

a) the core includes at least 50 wt% starch, exclusive of moisture, and has a spherical or oval shape having an aspect ratio not exceeding 3.0:1;

b) all components of the granules are food-safe;

c) the core includes moisture in a range from 1 wt% to 15 wt%;

d) the weight of the coating layer is in a range from 2% to 50% of the weight of the core; and

e) the smallest dimension of the core is in a range from 1 mm to 10 mm.

A foodstuff may be prepared by popping a multiplicity of the poppable granules.

### CROSS REFERENCE TO RELATED APPLICATIONS

This application claims priority of U.S. Provisional patent application 61/177,798, filed May 13, 2009, the entirety of which is incorporated herein by reference.

### BACKGROUND OF THE INVENTION

Consumers are interested in new and innovative snack products. Microwavable popped granulated snacks based on popcorn are very popular, but new popped snack products based on alternative foodstuffs are not widely available. Such products, if available, would find commercial utility.

### SUMMARY OF THE INVENTION

In one aspect, the invention provides a multiplicity of poppable granules each including a heat-expandable core encapsulated by a solid coating layer including a polymer. For at least 90 wt% of the granules:

a) the core includes at least 50 wt% starch, exclusive of moisture, and has a spherical or oval shape having an aspect ratio not exceeding 3.0:1;

b) all components of the granules are food-safe;

c) the core includes moisture in a range from 1 wt% to 15 wt%;

d) the weight of the coating layer is in a range from 2% to 50% of the weight of the core; and

e) the smallest dimension of the core is in a range from 1 mm to 10 mm.

In another aspect, the invention provides a foodstuff prepared by popping a multiplicity of poppable granules as described immediately above.

### BRIEF DESCRIPTION OF THE DRAWINGS

FIG. 1 is a photograph of non-encapsulated tapioca pearls prior to popping.

FIG. 2 is a photograph of encapsulated tapioca pearls prior to popping, according to the invention.

FIG. 3 is a photograph of the encapsulated tapioca pearls of FIG. 2 after popping, according to the invention.

### DETAILED DESCRIPTION OF THE INVENTION

The invention provides innovative snacks based on microwave popping of granules each consisting of a starch-containing core bead encapsulated by a solid coating layer comprising a polymeric material. The inventors have found that providing such an encapsulating layer on a starch-based core enables the granule to pop when heated rapidly, such as in a microwave oven. This popping is audible, and resembles the sound made when popcorn is prepared. Although the granules of this invention are not corn kernels, when popped they have an appearance resembling popcorn, possessing the characteristically irregular shape of popped popcorn referred to in the industry as a “flake.” The texture also resembles that of a popcorn flake.

It is important to distinguish between two different modes of heat-based expansion in starch-based materials. “Puffing” refers to a relatively slow expansion due to gradual formation of steam from water that is present in the uncooked material. “Popping” refers to a rapid, nearly explosive expansion attended by a nearly instantaneous release of pressurized steam within the granule, attended by an audible percussive sound. Preparation of popcorn is an example of the latter, as is cooking the granules of this invention.

As is known in the art, each kernel of popcorn has an interior consisting largely of starch, and each kernel has outer hull that is strong and impervious to moisture. Each kernel also contains a certain amount of moisture. As the water is heated past the boiling point, it forms a superheated pressurized steam that is contained within the moisture-proof hull. Under these conditions, the starch inside the kernel gelatinizes, softening and becoming pliable. The pressure continues to increase until the breaking point of the hull is reached, at which point it ruptures rapidly, causing a sudden drop in pressure inside the kernel and a corresponding rapid expansion of the steam, which expands the starch into a foam. As the foam rapidly cools, the starch again sets to produce a flake. Popping processes thus occur at ambient external pressure; i.e., and do not required the use of a pressure vessel.

In contrast to the present invention, puffing can be performed by continuous extrusion of a starch/water mixture at high temperature. In this case water constitutes at least 20 wt% of the mixture, and more typically at least about 35%. The water boils and flashes off as the mixture exits the extruder, resulting in puffing. This process requires that the mixture be in the form of a solution or slurry, because starch in the absence of water cannot be extruded but merely decomposes under the high extruder temperatures.

Microwave energy can be used to expand extruded starch pieces by a puffing process, but this process is relatively slow and not attended by a percussive sound, and is not example of popping according to the invention. An example of microwave “puffing” is described in “Factors That Influence the Microwave Expansion of Glassy Amylopectin Extrudates”, Boischot, C., Moraru, C. I., Kokini, J. L., Cereal Chemistry, 2003, Volume 8, Number 1, pp 56 -61.

Another method of puffing is used to make puffed cereals, and uses a special kind of autoclave. Wheat or rice grain is saturated with water and heated in the autoclave under pressure at a temperature above the normal ambient boiling point of water. The pressure is quickly released, leading to a rapid expansion of the water that “puffs” the grain. This method requires the use of an external pressure device, and contrasts with the present invention, in which no external pressure need be applied to effect popping.

Starch-containing core beads

Core beads suitable for encapsulation (to be described below) contain a significant amount of starch. No specific lower limit has been determined, but in general an amount of 50% or more is suitable. Typically, the core will contain at least 60 wt%, or at least 70 wt%, or at least 80 wt%, or at least 90 wt% of starch, more typically at least 95 wt%, and most typically at least 98 wt%. These percentages refer to the constituents of the granules other than moisture. Nonlimiting examples of suitable starches for forming the core may include those derived from corn, wheat, tapioca, rice and potato. The core beads may also incorporate flavors, colors, protein, fiber, vegetable powders, minerals, vitamins, etc., any of which may be included in the core when it is formed. Sweeteners may be included, for example sucrose and/or a high intensity non-nutritive sweetener such as sucralose. Suitable flavorants may also include diacetyl, which provides a buttery flavor, and aroma compounds such as 6-acetyl-2,3,4,5-tetrahydropyridine and 2-acetyl-1-pyrroline. Others will be apparent to the person of skill in the food flavorant art. The moisture content of the granules will typically be at least 1 wt% based on core weight, and more typically at least 3 wt%, most typically at least 5 wt%. The moisture content will typically be at most 15 wt%, more typically at most 12 wt%, and most typically no greater than 10 wt%.

One suitable type of core bead is available commercially as so-called tapioca “pearls.” These are nearly perfectly spherical, and consist essentially of starch. Tapioca pearls may be prepared by methods well known in the art. For example, they may be made by mixing tapioca flour (which consists essentially of starch) with water to make a dough, which is slowly cooked and stirred. By the end of this process, the tapioca has dried again into so called “flakes.” These are reduced in size in hammer mills and dried in warm air before cooling, grinding, and screening to produce uniform granules. Modifications of this technique to include other ingredients may be made, for example to include flavorants, etc. as discussed above. The core bead may also be a seed or other naturally occurring starch-containing granular material, which can be coated with the encapsulating coating. In this way, a starch-containing item with no shell (or a weak one) may also be made poppable.

The size of the core beads is not critical, but the smallest dimension of at least 90 wt% of the cores will typically be at least 1 mm, or at least 2 mm, or at least 3 mm. The smallest dimension will typically be at most 10 mm, or 7 mm, or 5 mm. In general, the inventors have found that larger granules pop more reliably than smaller ones. The shape of the core should be approximately spherical, although generally oval shapes are acceptable. At least 90 wt% of the cores should be of such shapes, and at least 90 wt% of the cores should have an aspect ratio not exceeding 3.0:1 when viewed from any direction. Typically, the aspect ratio for at least 90 wt% of the cores will be at most 2:1, or at most 1.5:1, or at most 1.2:1. These sizes, shapes and aspect ratios may also apply to the granules formed by encapsulating the cores with the coating layer.

Encapsulation of core beads

The encapsulating coating layer comprises a food-safe polymeric material. Suitable coating materials include any of a number of polymers, for example food gums. Suitable polymers include film-forming polymers, and specific examples include food shellac, gum arabic, carboxymethyl cellulose, guar, xanthan, pullulan, and modified starches. The encapsulating coating may optionally contain dextrose, which may help keep viscosity low while providing a high-solids coating composition. The coating may also contain one or more of maltodextrin, trehalose, maltose and sucrose. The encapsulating layer in the granules is typically applied at a loading (on a dry basis) of at least 2% of the core weight, more typically at least 5%, and most typically at least 10%. Generally, the loading is at most 50% relative to the core weight, more typically at most 40%, and most typically at most 30%.

The encapsulating coatings may be applied by any means known in the art, including for example pan coating and coating on a fluid bed granulator. Typically, the coatings will be applied as aqueous solutions or dispersions, although food-safe solvents such as ethanol and ethyl acetate may also be used. Coating by other processes may also be acceptable, such as by applying a curable polymeric composition with or without solvent to the core. Melt-coating of suitable polymeric compositions may also be suitable in some embodiments. The encapsulating coatings of this invention are to be understood as layers that are applied to a pre-formed core, and thus popcorn kernels do not have an encapsulating coating as defined herein.

Since the product is intended to be eaten, all components used in making the granules of this invention should be food-safe. As used herein, the term “food-safe” means ingredients that comply with U.S. Food and Drug Administration requirements for foods and food ingredients.

### EXAMPLES

A sample of large pearl tapioca purchased from Bulk Foods.com was coated with a solution of pullulan and 24 dextrose equivalent corn syrup solids (STAR-DRI® 240, available from Tate & Lyle of Decatur, IL) using a Glatt ProCell 5 Fluid Bed Granulator. The following processing parameters were used. Large pearl tapioca has a diameter of about 5-7 mm, and small pearl is about 2-4 mm.

| | |
|---|---|
| Bed | 300 g Large Pearl Tapioca |
| Binder | 40 g Pullulan, 20 g STAR-DRI ® 240, 240 g |
| | Deionized Water |
| Nozzle | Bottom Spray |
| Fluidization | 230 m³/hr |
| Inlet Air | 45° C.-50° C. |
| Product | ~44° C. |
| Atomization | 2.0 bar |
| Spray Rate | ~5.5 g/min |

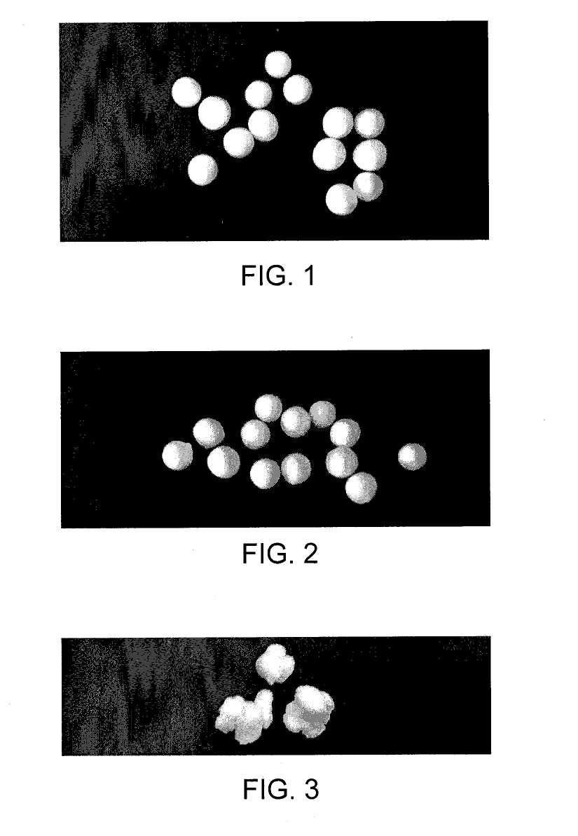

FIGS. 1 and 2 show non-encapsulated and encapsulated tapioca pearls, respectively, prior to popping. FIG. 3 shows the encapsulated tapioca pearls of FIG. 2 after popping. All images are at the same magnification.

Cooking was performed as follows. The encapsulated sample was placed in a glass beaker and heated in a Sharp Carousel II microwave oven set at normal power for approximately 90 seconds. At approximately 60 seconds, the first granule popped audibly, creating an expanded, popcorn-like tapioca piece. Several other granules also popped in the microwave oven, but most did not. The flavor and texture of the popped product were very similar to those of popcorn. The same process was carried out using small and large pearl tapioca pearls that were not encapsulated, and none of these popped.

Several pieces of the encapsulated large pearl tapioca were placed in a commercial microwave popcorn bag equipped with a microwave susceptor, and the bag was folded closed and heated in the microwave oven. Popping began after approximately 60 seconds, and most of the granules popped.

Non-encapsulated large and small pearl tapioca pieces were also placed in microwave popcorn bags and heated in the microwave oven. A few, but not most, of the pieces expanded by puffing, but none popped. Those that did expand were noticeably less expanded than the popped encapsulated pearls.

Although the invention is illustrated and described herein with reference to specific embodiments, the invention is not intended to be limited to the details shown. Rather, various modifications may be made in the details within the scope and range of equivalents of the claims without departing from the invention.

What is claimed:

1. A multiplicity of poppable granules each comprising a heat-expandable core encapsulated by a solid coating layer comprising a polymer, wherein for at least 90 wt% of the granules:
a) the core comprises at least 50 wt% starch, exclusive of moisture, and has a spherical or oval shape having an aspect ratio not exceeding 3.0:1;
b) all components of the granules are food-safe;
c) the core comprises moisture in a range from 1 wt% to 15 wt%;
d) the weight of the coating layer is in a range from 2% to 50% of the weight of the core; and
e) the smallest dimension of the core is in a range from 1 mm to 10 mm.

2. The multiplicity of poppable granules according to claim 1, wherein the core comprises moisture in a range from 3 wt% to 12 wt%.

3. The multiplicity of poppable granules according to claim 1, wherein the core comprises moisture in a range from 5 wt% to 10 wt%.

4. The multiplicity of poppable granules according to claim 1, wherein the weight of the coating layer is in a range from 5% to 40% of the weight of the core.

5. The multiplicity of poppable granules according to claim 1, wherein the polymeric material comprises pullulan.

6. The multiplicity of poppable granules according to claim 5, wherein the coating further comprises corn syrup solids.

7. The multiplicity of poppable granules according to claim 1, wherein the core comprises tapioca.

8. The multiplicity of poppable granules according to claim 1, wherein the core comprises at least 90 wt% starch.

9. The multiplicity of poppable granules according to claim 1, wherein the core comprises at least 95 wt% starch.

10. The multiplicity of poppable granules according to claim 1, wherein the core further comprises a flavorant or aroma compound.

11. A foodstuff prepared by popping a multiplicity of poppable granules according to claim 1.
